(19) United States
(12) Patent Application Publication
(10) Pub. No.: US 2026/0245050 A1
(43) Pub. Date: Aug. 20, 2026

(54) SYSTEM, METHOD, AND APPARATUS FOR MINIMIZING ENVIRONMENTAL IMPACT THROUGHOUT A VALUE CHAIN

(71) Applicant: Merck Patent GmbH, Darmstadt (DE)

(72) Inventors: Joy Watanabe, Campbell, CA (US); Vijay Kris Narasimhan, Collinsville, CT (US); Arie Van Gent, Mountain View, CA (US); Benjamin Kuehne, Biebesheim (DE)

(21) Appl. No.: 19/471,018

(22) PCT Filed: Mar. 27, 2024
(86) PCT No.: PCT/EP2024/058237

§ 371 Date: Sep. 30, 2025

Related U.S. Application Data
(60) Provisional application No. 63/493,387, filed on Mar. 31, 2023.

(51) Int. Cl. G06Q 10/30; G06Q 50/04

(52) U.S. Cl. CPC G06Q 10/30; G06Q 50/04

(57) ABSTRACT

A device, and related method and system, are disclosed that includes a processor configured to: estimate a first environmental impact value for a first subcomponent of a process for a first user account. The first subcomponent of the process is affected by a first process parameter. The processor estimates a second environmental impact value for a second subcomponent of the process for the first user account. The second environmental impact value is affected by a second process parameter. The second user account is associated with the second process parameter and the second subcomponent of the process. The processor also modifies the first sub-component of the process to minimize an environmental footprint in accordance with the first and second environmental impact values.

### BACKGROUND

### Relevant Field

The present disclosure relates to environmental aspects of manufacturing processes. More particularly, the present disclosure relates to a system, method, and apparatus for minimizing environmental impact throughout a value chain of a manufacturing process.

### Description of Related Art

Large industries, such as the chemical or the automotive sector, are dependent on the resilience, transparency, and flexibility of supply chains. In some cases, a data ecosystem is used to facilitate the sharing of information from one supplier to the next. One prominent data ecosystem for a large industry is Catena-X, which was developed for the automotive sector to deliver a trustworthy, collaborative, open, and secure digital environment where all companies are networked in an end-to-end manner from the perspective of the value chains.

Digital governance is developed by initiatives such as Gaia-X. According to Catena-X, all partners are on an equal ground, have sovereign control over their data and no lock-in effects occur, which provides a sustainable solution for the digitalization of supply chains.

Government agencies and companies are increasingly adopting sustainability practices into their daily operations, either in response to new regulations (e.g., the EU Green New Deal) or in terms of aggressive targets to mitigate climate change and other environmental degradation (e.g., science-based targets for greenhouse gas emission reductions). Many environmentally significant emissions, like greenhouse gases and wastewater, can be classified into three “scopes”: direct emissions (scope 1), emissions from purchased energy (scope 2), and emissions from transportation, raw materials, and consumption (scope 3). In many industries, scope 3 emissions can be significant. For example, the manufacturing of integrated circuits and displays for IT devices can account for 45% of the total carbon footprint of a consumer electronics company, including the materials, while 20% comes from the use of products (See U. Gupta et al., “Chasing Carbon: The Elusive Environmental Footprint of Computing,” 2021 IEEE International Symposium on High-Performance Computer Architecture (HPCA), 2021). Calculating the environmental footprint of upstream (i.e., supplier) and downstream (i.e., customer) processes may thus be desired. The information should be consistently measured, calculated, and shared; however, large consortia have noted that “There is currently no harmonized and specific approach . . . and [the] data shared is often not directly comparable.”—Together for Sustainability Consortium.

### SUMMARY

A system of one or more computers (computer system) can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include estimating, preferably using a first processor, a first environmental impact value for a first subcomponent of a process for a first user account, the first subcomponent of the process being affected by a first process parameter. The method may also include estimating, preferably using a second processor, a second environmental impact value for a second subcomponent of the process for the first user account, the second environmental impact value being affected by a second process parameter, a second user account being associated with the second process parameter and the second subcomponent of the process. Herein, the first processor and the second processor may be identical. Furthermore, estimating of a first or second environmental impact value may include calculating, for example using the first and/or the second processor, for example as part of a computer system, an estimate of the first environmental impact value or the second environmental impact value. In general, for the purposes of the present disclosure, estimating of a value may include calculating, for example using a processor, for example as part of a computer system, an estimate of the environmental impact value and further may include calculating one or more parameters from which the estimate of the environmental impact value can be derived of. The method may furthermore include modifying the first subcomponent of the process to minimize an environmental footprint in accordance with the first and second environmental impact values. Embodiments of this aspect may include corresponding computer systems, apparatus, and/or computer programs recorded on one or more computer storage devices, each configured and used to perform one or more, preferably all steps of the method.

Implementations may include one or more of the following features. A method that includes securely communicating the first process parameter corresponding to the first subcomponent of the process to a computing device for the first user account; estimating the second environmental impact value for the second subcomponent of the process on the computing device using the first process parameter; and securely communicating the second environmental impact value to the first user account. The method may be implemented where the first user account is prohibited from accessing at least one component of the second subcomponent of the process. The method may be implemented where the first process parameter is one of a choice of material, a choice of use of a material, and a choice of and use of a material.

The method may be implemented where the modification of the first subcomponent of the process occurs prior to an execution of the second subcomponent of the process. The method may be implemented where the first subcomponent of the process is performed on a separate and distinct production line relative to the second subcomponent of the process. The method may be implemented where the first environmental impact value is one of an energy expenditure, a processing time, a solvent use, a transportation metric, a waste disposal amount, a greenhouse gas amount, a carbon footprint, a water usage, and an ESG metric. The method may be implemented where the first and second user accounts are separate parties.

The method may include executing a process model to determine the environmental footprint. The method may be implemented where the process model includes at least one process step. The method may be implemented where the at least one process step includes at least one input. The method may be implemented where the at least one process step calculates at least one output. The method may be implemented where the process model includes a factor lookup table configured to associate at least one material with a normalized environmental footprint. The method may be implemented where the factor lookup table includes a hierarchical factor value for each entry. The method may include: modifying the process model in accordance with the first user account by inheriting the process model; and overriding a behavior of the process model to estimate the first environmental impact value.

The method may include: modifying a process model in accordance with the first user account; and adjusting at least one transparency parameter in relation to the second user account. For the purposes of the present disclosure, the term “transparency parameter” generally means a parameter that has an influence on the transparency of a user account. The method may be implemented where a process model is implemented as a smart contract on a blockchain. The method may be configured where a process model interfaces with a common data lake. The method may be implemented where a process model is implemented on a secured distributed computing network. The method may be implemented where a process model is configured to output at least one of a scope 1 environmental footprint, a scope 2 environmental footprint, and a scope 3 environmental footprint. The method may include injecting obscuration noise into the first environmental impact value. The method may include estimating a confidence score corresponding to the first environmental impact value. The method may be implemented where one or more subcomponents may be interposed between the first subcomponent and the second subcomponent, where the one or more subcomponents are not associated with any user accounts. Implementations of the described techniques may include hardware, a method or process, or a computer tangible medium. It should be noted that the above and hereinafter described process models may be identical but also may be different unless specifically referred to as “the process model”. For example, a first process model, a second process model, and a third process model may be used. In particular, a different process model may be used for each party receiving a process model, or the same process model may be used for each party receiving a process model. For example, a system as described below may be configured to distribute a generic process model to some of the parties or to each party. Preferably a party can customize the process model they received.

In one general aspect, a system, preferably a computer system, for minimizing environmental impact throughout a value chain by communicating between process silos may include one or more processors configured to: estimate a first environmental impact value for a first subcomponent of a process for a first user account, the first subcomponent of the process being affected by a first process parameter; estimate a second environmental impact value for a second subcomponent of the process for the first user account, the second environmental impact value being affected by a second process parameter, a second user account being associated with the second process parameter and the second subcomponent of the process; and modify the first subcomponent of the process to minimize an environmental footprint in accordance with the first and second environmental impact values. Embodiments of this aspect may include corresponding computer systems, apparatus, and/or computer programs recorded on one or more computer storage devices, each configured to perform the actions of the methods.

Implementations may include one or more of the following features. The one or more processors may be further configured to: securely communicate the first process parameter corresponding to the first subcomponent of the process to a computing device for the first user account estimate the second environmental impact value for the second subcomponent of the process on the computing device using the first process parameter; and securely communicate the second environmental impact value to the first user account. The system may optionally be configured so that the first user account is prohibited from accessing at least one component of the second subcomponent of the process. The system may optionally be configured where the first process parameter is one of a choice of material, a choice of use of a material, and a choice of and use of a material. The system may be such that the modification of the first subcomponent of the process occurs prior to an execution of the second subcomponent of the process. System where the first subcomponent of the process is performed on a separate and distinct production line relative to the second subcomponent of the process.

The system may be configured where the first environmental impact value is one of an energy expenditure, a processing time, a solvent use, a transportation metric, a waste disposal amount, a greenhouse gas amount, a carbon footprint, a water usage, and an ESG metric. The system may be configured where the first and second user accounts are separate parties. The system may be configured so that the one or more processors are further configured to execute a process model to determine the environmental footprint. The system may be configured where the process model includes at least one process step. The system may be configured where the at least one process step includes at least one input. The system may be configured where the at least one process step calculates at least one output. The system may be configured where the process model includes a factor lookup table configured to associate at least one material with a normalized environmental footprint. The system may be configured where the factor lookup table includes a hierarchical factor value for each entry. The one or more processors may be further configured to: modify the process model in accordance with the first user account by inheriting the process model; and override a behavior of the process model to estimate the first environmental impact value.

The one or more processors may be further configured to: modify a process model in accordance with the first user account; and adjust at least one transparency parameter in relation to the second user account. The system may optionally be configured such that a process model is implemented as a smart contract on a blockchain. The system may be configured where a process model interfaces with a common data lake. The system may be configured where a process model is implemented on a secured distributed computing network. The system may be configured where a process model is configured to output at least one of a scope 1 environmental footprint, a scope 2 environmental footprint, and a scope 3 environmental footprint.

The system may include one or more processors further configured to inject obscuration noise into the first environmental impact value; and/or estimate a confidence score corresponding to the first environmental impact value. The system may be configured such that one or more subcomponents may be interposed between the first subcomponent and the second subcomponent, wherein the one or more subcomponents are not associated with any user accounts. Implementations of the described techniques may include hardware, a method or process, or a computer tangible medium.

In one general aspect, an apparatus may include one or more processors. The apparatus may also include a plurality of processor executable instructions configured for execution on the one or more processors, where the plurality of processor executable instructions is configured to cause the one or more processors to: estimate a first environmental impact value for a first subcomponent of a process for a first user account, the first subcomponent of the process being affected by a first process parameter; estimate a second environmental impact value for a second subcomponent of the process for the first user account, the second environmental impact value being affected by a second process parameter, a second user account being associated with the second process parameter and the second subcomponent of the process; and modify the first subcomponent of the process to minimize an environmental footprint in accordance with the first and second environmental impact values. Other embodiments of this aspect include corresponding computer systems, apparatus, and computer programs recorded on one or more computer storage devices, each configured to perform the actions of the methods. The apparatus may comprise the system according to the present disclosure, wherein the one or more processors of the apparatus are the one or more processors of the system.

In one general aspect, the system according to the present disclosure and/or the apparatus according to the present disclosure is used for carrying out the method according to the present disclosure.

The method according to the present disclosure may be carried out using the system according to the present disclosure and/or the apparatus according to the present disclosure.

### BRIEF DESCRIPTION OF THE DRAWINGS

These and other aspects will become more apparent from the following detailed description of the various embodiments of the present disclosure with reference to the drawings wherein:

FIG. 1 shows a block diagram illustration of a cloud-based system to minimize the environmental footprint of a manufacturing process along a value chain in accordance with an embodiment of the present disclosure;

FIG. 2 show a block diagram illustration of a computing device to minimize the environmental footprint of a manufacturing process along a value chain in accordance with an embodiment of the present disclosure; and

FIG. 3 is a diagram illustrating an object in an object-oriented programming paradigm for providing a process model to minimize the environmental footprint of a manufacturing process along a value chain in accordance with an embodiment of the present disclosure; and

FIG. 4 shows a flow chart diagram of a method to minimize the environmental footprint of a manufacturing process along a value chain in accordance with an embodiment of the present disclosure.

### DETAILED DESCRIPTION

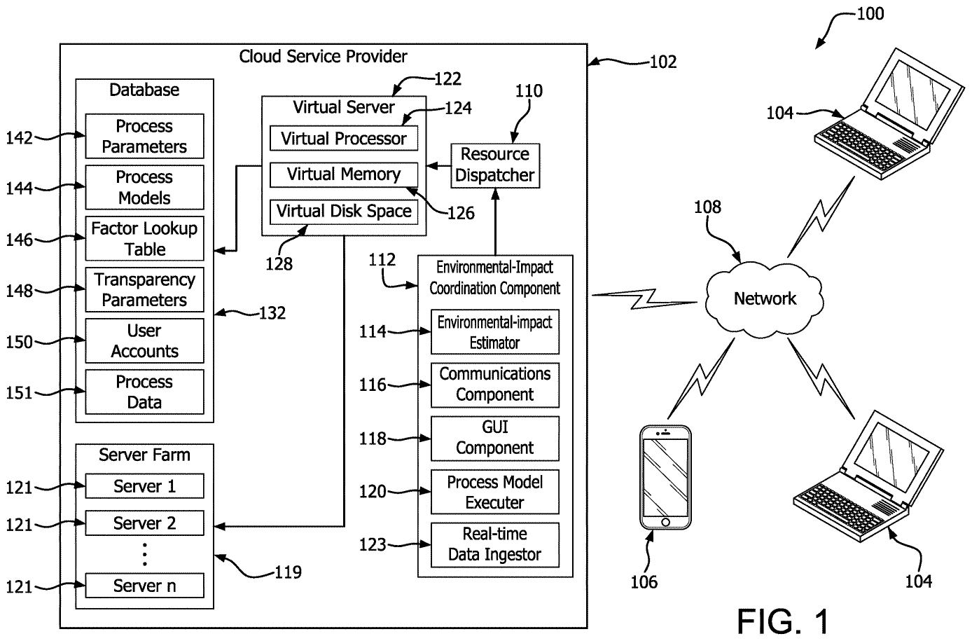

FIG. 1 shows a block diagram illustration of a cloud-based system 100 to minimize the environmental footprint of a manufacturing process along a value chain in accordance with an embodiment of the present disclosure. The system 100 includes a cloud-service provider 102, one or more personal computers 104, and a mobile device 106. The system 100 also includes an environmental-impact coordination component 112. The environmental-impact coordination component 112 can provide coordination functionality between multiple entities so that a manufacturing process, as a whole, minimizes environmental impact throughout the entire value chain as described below in more detail.

The system 100 is configured to reduce the environmental footprint of a manufacturing process distributed between multiple parties by mitigating information silos of information in a manner to co-optimize subcomponents of a manufacturing processes. Note that the sub-components to be co-optimized do not necessarily need to be adjacent or contiguous to each other, e.g., there could be zero or more interposed subcomponents of the process between the subcomponents being co-optimized. The system 100 is configured to distribute a generic process model to each party. The parties do not always need to have any relationship between each other, such as a formal, legal, or informal relationship, but could have a relationship including being suppliers, equipment providers, shipping providers, customers, etc. of each other. There are numerous established and emerging methods for calculating environmental footprints, for example the product/process mass intensity, the GHG protocol, ISO Standard 14067:2018, and the together for sustainability protocol. However, sharing the information between different parties is not so straightforward. A critical problem that hampers sharing is the sensitivity of sustainability information.

The environmental footprint of a product depends on the specific inputs and processes used to produce it. However, sharing all or some of the sub-components involved in a product or process may run the risk of revealing proprietary information that could compromise trade secrets. A compromise that preserves some privacy while allowing companies to comply with regulations and targets is the concept of a stamp, sticker, “price tag,” or passport. The footprint of a product could be estimated using one of the standards described earlier, and the final footprint (without the underlying calculations) could be provided as a digital or physical sticker accompanying the product. In some embodiments, a sticker can be configured to preserve privacy while having just enough information for a downstream member of the value chain to make certain product selections. This sticker may be analogous to the idea of budgeting; if a company has a certain environmental footprint “budget” for producing a product, they can select raw materials and processes that fit this budget so long as they know the individual footprints. In some embodiments, a sticker may be configured to increase transparency while still preserving the security of proprietary information. For example, clustering environmental impacts from certain classes of materials or types of processes, obfuscating or normalizing some data, adding noise, employing differential privacy algorithms, and employing paradigms from federated analytics are all methods that the system 100 may implement.

In yet additional embodiments, the system 100 may be utilized in the chemical industry to minimize the environmental impact throughout the entire value chain by facilitating the use of various data ecosystems and/or data sharing platforms such as simple file-sharing services to more advanced platforms with tools for data analysis and visualization. The system 100 may include interfaces into SiGreen from Siemens, GreenToken by SAP, and CO2AI by BCG. The system 100 may be utilized to share meta data, quality ratings for the exchanged data, automated updates, and notifications according to existing quality standards like the GHG protocol or ISO norms are possible.

The cloud-service provider 102 may be configured to facilitate the coordination of different users to minimize an environmental impact throughout a value chain. In some embodiments of the present disclosure, the cloud service provider 102 may be a hosted service such as a company that offers cloud computing services to businesses and individuals such that the cloud service provider 102 provides the infrastructure, software, and platforms required to host, manage, and deliver cloud-based services.

In some embodiments, the cloud service provider 102 may provide infrastructure as a service, platform as a service, software as a service, and/or may be an interface into a blockchain infrastructure that may or may not be hosted by the cloud service provider 102. The cloud service provider 102 may be configured to scale up or down its computing resources based upon demand from users at a given moment.

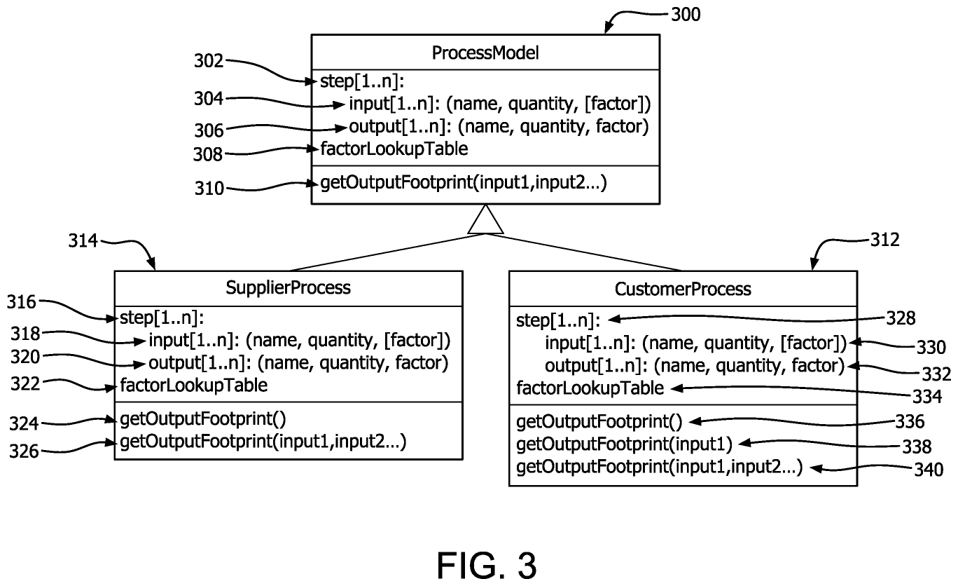

In yet other embodiments, the cloud service provider 102 may be implemented on a block chain that leverages smart contracts that are configured to minimize the environmental impact by coordinating subcomponents of a manufacturing process between users (further described below). The cloud service provider 102 may utilize a distributed ledger to store and verify environmental impact data generated by one or more process models 300 (see FIG. 3) and to communicate one or more of steps 302, inputs 304, outputs 306, and footprints 310, etc. among different users. Users may be authenticated and/or authorized by a secure digital certificate, encryption key, or other secure mechanism. The data may be stored and calculated in a secure and tamper proof manner to provide transparency and accountability to all users. The smart contracts may include executable code that defines a manufacturing process in terms of one or more process models 300 in a manner consistent with transparency and security settings.

Referring generally to the system 100, the personal computers 104 and the mobile device 106 communicate with each other via a network 108. The network 108 may be Wi-Fi, ethernet, Bluetooth, etc. and may utilize the internet and associated protocols, such as TCP/IP. The network 108 may be a local area network, a wide-area network, a physical bus (such as a Universal Serial Bus), the internet, or some combination thereof.

The personal computer 104 and mobile device 106 may interface with the cloud-service provider 102 to coordinate the minimization of the total environmental impact as determined by the environmental-impact estimator 114. In some embodiments, a specialized application for interfacing with an environmental-impact coordination component 112 may be used, such as a mobile application on the mobile device 106 or a desktop application on the personal computer 104. The communications may include transmitting data in HTML, XML, JSON, YAML, or any data format. The environmental-impact coordination component 112 may provide user-level accounts to individuals through a typical login mechanism. The environmental-impact coordination component 112 may be a web application, a webserver, a web service, etc. and may utilize one or more protocols to communicate data.

The cloud-service provider 102 may provide the environmental-impact coordination component 112 as a webpage, a webapp, a program for download and execution on the computer 104 or the mobile device 106. The environmental-impact coordination component 112 includes an environmental impact estimator 114, a communications component 116, a GUI component 118, and a process model executer 120.

The environmental-impact estimator 114 can utilize, including but not limited to, one or more of scope 1, scope 2 or scope 3 greenhouse gas emissions, wastewater emissions, environmental impact values, or some combination thereof to determine an environmental footprint. In some embodiments, the environmental-impact estimator 114 adds together the total environmental impact values of the various subcomponents of a process, according to type, as reported by the process model executer 120. In other embodiments, the environmental-impact estimator 114 may use any number of linear, nonlinear, parametric, non-parametric, etc. functions to estimate a total environmental footprint. For example, waste volumes of one type of waste may be added together from all the subcomponents of a process and multiplied by a first constant, which are added to the carbon dioxide output volume totals from all of the subcomponents and multiplied by a second constant. The resulting value may be deemed to be a heuristic measuring the total environmental footprint of a process, in some specific embodiments. In yet additional embodiments, the environment-impact estimator 114 may be omitted such that raw environmental impact values are reported to the parties associated with the relevant user accounts 150.

In some embodiments, the environment-impact estimator 114 may assign a confidence score. If the environment-impact estimator 114 bases some or all of the estimates on data, models generated from data, or Monte Carlo simulation data, a confidence score can be assigned to the estimates of an environmental impact value to indicate the quality of the estimate. This could be included directly in the output or be derived from the standard deviation or variance in the sample data used to make the estimation, the min-max of all environmental impacts of a specific class of material, etc.

In one embodiment, a frequentist confidence store may be derived using frequentist statistics. For example, a confidence score may use sample data of a distribution, hypothesis testing, p-values, significance testing, confidence intervals etc. In additional embodiments, a confidence score is calculated for each (or a set of) environmental impact sample values using posterior probabilities in a Bayesian estimate, which represent the updated belief about the environmental impact value estimates. Thus, the confidence score, for example, may be a credible interval of a posterior distribution or of a Bayesian estimator.

In yet additional embodiments, the environment-impact estimator 114 may introduce random noise, for example, from a Gaussian or white noise on top of the constant used to generate estimated environmental impact values. This noise may be configured such that the aggregate sum of the noisy environmental impact estimates for the components of a particular product or process do not perturb the true environmental footprint by more than a specific amount or more than predetermined criteria, following the algorithms of differential privacy, for example. The environment-impact estimator 114 may be configured to use the noise to further protect privacy in terms of the identity of ingredients or thwart inference attacks that may be made by reverse (or other) lookups in the database 132.

The process model executer 120 may execute one or more of the stored process models 144 (also see process model 300 of FIG. 3), to determine the environmental impact values for one or more subcomponents of a target process along a value chain. The process model executer 120 may be executable code configured to execute, interpret, or utilize the process models, for example using a virtual processor 124, in a manner to report the environmental impact values to the environmental impact estimator 114.

The environmental-impact coordination component 112 also includes the communications component 116. The communications component 116 may facilitate seamless communication and data exchange between multiple software applications, devices, and systems. That is, the communications component 116 may include protocol handling, message formatting, data serializing, encryption, and authentication to facilitate the communication with the computers 104 and/or the mobile device 106. The communications component 116 may utilize a message formatting mechanism to format the messages into formats, such as XML, JSON, binary formats, and/or proprietary message formats. The communications component 116 may utilize various encryption algorithms, such as RSA, AES, ECC, symmetric encryption, asymmetric encryption etc. to enable secure communications between the environmental-impact coordination component 112 and the computers 104 and/or the mobile device 106.

The environmental-impact coordination component 112 also includes a real-time data ingestor 123. The real-time data ingestor 123 may be a real-time or near real-time ingestor configured to collect and collate process data 151. The process data 151 may be stored in the database 132. The process data 151 may be associated with a user account 150, a process model 144, one or more process parameters 142, a factor lookup table 146, and/or transparency parameters 148. The real-time data ingestor 123 may be configured to securely communicate with Internet-of-Things devices, edge devices, control blocks, DIN controllers, various sensors etc. coupled to or in communication with a process or subcomponent of a manufacturing process.

The GUI component 118 can render a display for use by the computer 104 and/or the mobile device 106. The GUI component 118 may be a webpage-based provider, such as flask, an HTML server, a web framework, etc. The GUI component 118 may provide widgets, information, buttons, options, and menus to thereby facilitate a user's interaction with the environmental-Impact Coordination Component 112.

The GUI component 118 can be used to log into user accounts 150 so that a user can create, save, or retrieve process models 144, adjust transparency parameters 148, adjust process parameters 142, review of retrieve process data 151, or otherwise interface with any account features. Additionally or alternatively, the GUI component 118 can save favorites, select default parameters, or adjust the factor lookup table 146. The GUI component 118 can direct other components to execute instructions based upon a workflow initiated by a user. That is, the GUI component 118 may receive events, such as a mouse click, button press, or GUI widget interaction to initiate a routine, series of steps, or series of acts. For example, the GUI component 118 may guide a user step-by-step on how to set up and work with the process models 144 within the database 132.

The GUI component 118 may also be used to visualize the results of the process models and the environmental impact values, in aggregate, in simulation, and/or may provide various visualization tools to analyze the data. The data may be stored in the database 132 including the process data 151. Thus, each user can log into a user account 150 to visual the results of their processes, the results of modifications to their processes on the entire value chain, and/or historical accuracy of their process environmental impact value estimates.

A resource dispatcher 110 may dispatch requests to perform an action to one or more virtual servers 122, each of which has a virtual processor 124, a virtual memory 126, and a virtual disk space 128. The virtual servers 122 can be executed on one or more servers 121 on a server farm 119 as dispatched and activated by the resource dispatcher 110.

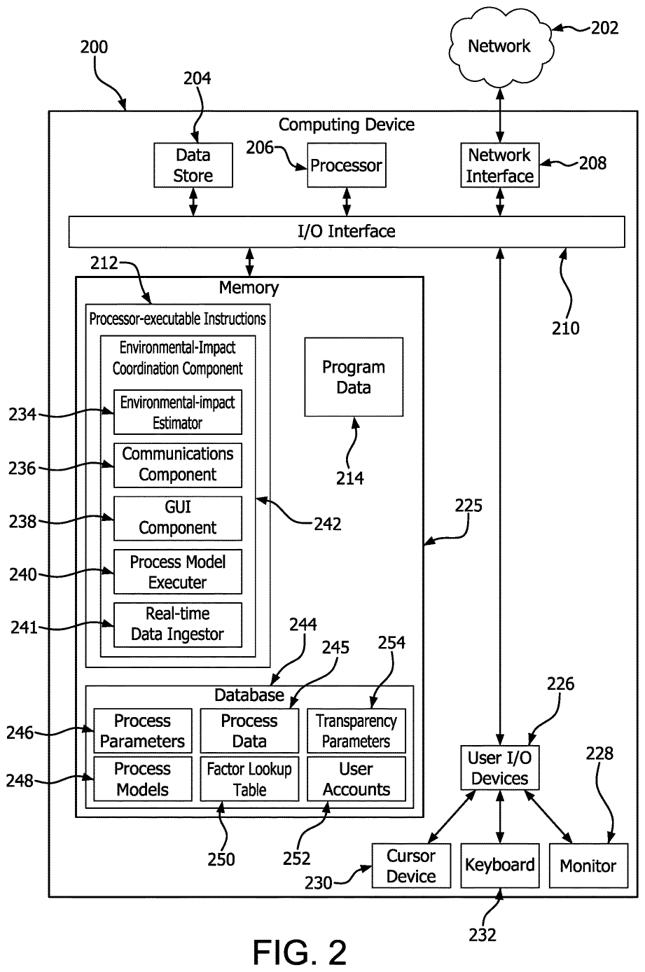

FIG. 2 show a block diagram illustration of a computing device 200 to minimize the environmental footprint of a manufacturing process along a value chain in accordance with an embodiment of the present disclosure. The computing device 200 of FIG. 2 may be the computer 104 or mobile device 106 of FIG. 1. The computing device 200 includes an I/O interface 210 to communicate therewithin. The computing device 200 includes a data store 204, a processor 206, a network interface 208, a memory 225, and user I/O devices 226. The data store 204 stores data and may be a hard drive, flash drive, thumb drive, volatile memory, non-volatile memory, semi-volatile memory etc. The processor 206 can execute one or more processor-executable instructions 212, which may be stored in the data store 204 and/or the memory 225. For example, the processor 206 can execute processor-executable instructions 212 stored in memory 225 that was retrieved from the data store 204. The memory 225 also includes program data 214 that may include information related to the processor-executable instructions 212. The computing device 200 may include user I/O devices 226, such as a cursor device 230 (e.g., touchscreen or mouse), a keyboard 232 (virtual or physical), and/or a monitor 228 (which may be a touchscreen). The computing device 200 communicates with the network 202 via a network interface 208.

Although the computing device 200 of FIG. 2 may be used as part of the system 100 of FIG. 1, in some embodiments, the environmental impact minimization functionality may reside wholly within the computing device 200 of FIG. 2. For example, the environmental-impact coordination component 112 of FIG. 1 may reside within the processor-executable instructions 212 of FIG. 2 as environmental-impact coordination component 242. For example, the environmental-impact estimator 234, the communications component 236, the GUI component 238, the process model executer 240, and the real-time data ingestor 241 of FIG. 2 may have the same or similar functionality as the environmental-impact estimator 114, the communications component 116, the GUI component 118, the process model executer 120, and the real-time data ingestor 123 of FIG. 1, respectively. The database 244 may be similar to the database 132 of FIG. 1. The database 244 may, for example, be an SQLite 3 database embedded on the computing device 200.

Thus, in some embodiments the environmental-impact coordination component 242 may reside wholly on a local device (such as on the computers 104, the mobile device 106, etc.) may be partially within a cloud service provider 102, and/or may be organized in a hybrid local and cloud configuration. In some embodiments, the environmental-impact coordination component 242 may be an application, may be executed on the computers 104, the mobile device 106, the cloud service provider 102, the computing device 200, etc. or some combination thereof.

The database 244 of FIG. 2 may be like or identical to the database 132 of FIG. 1. That is, the process parameters 246, the process models 248, the factor lookup table 250, the user accounts 252, the transparency parameters 254, and the process data 245 may be similar or identical to the process parameters 142, the process models 144, the factor lookup table 146, the user accounts 150, the transparency parameters 148, and the process data 151 of FIG. 1, respectively.

FIG. 3 shows a diagram illustrating an object in an object-oriented programming paradigm for providing a process model 300 to minimize the environmental footprint of a manufacturing process along a value chain in accordance with an embodiment of the present disclosure. The process model 300 may be inherited by a supplier process 314 or a customer process 312. The process model 300 includes steps 302 which is an attribute that is a list of other attributes, such as input 304 attributes and output attributes 306. The input 304 attribute may be a list of tuples, for example, of name, quantity, and optionally, factor values. The output 306 attribute may be a list of tuples of name, quantity and optionally, factor values. An output 306 attribute 306 may be an input into a next item in a list of the step 302 attribute (which may be an input 304 attribute (this type of data relationship may be accomplished with lists, such as linked lists, for example).

Thus, the process model 300 may consist of a series of one or more steps 302, with each step 302 having a set of one or more inputs 304 (including but not limited to raw materials, consumables, catalysts, equipment, waste treatments, water usage, and energy) and one or more outputs 306. Outputs 306 may be products, intermediates, or final items. The inputs 304 and outputs 306 may each have one or more quantities associated with them (e.g., a mass, a volume, a density, a purity, an isotope ratio, a contamination percentage, a reaction completion, a hydrolysis measure, a precipitate measure, a salinity, a concentration, unit of energy used, etc.).

The process model 300 also includes a factor lookup table 308 as an attribute. The factor lookup table 308 associates certain materials with certain normalized environmental footprints, such as specific factors for water and carbon dioxide. For example, a solvent may have a carbon footprint of 2.3 kg of CO2 equivalent per kg of solvent, while a drug substance may have a carbon footprint of 5.5 kg of CO2 equivalent per kg of solvent. Each of these individual footprints may be links to external databases containing “default” footprints or may be imported into the factor lookup table 308 from external sources. A particular item can have a hierarchy of factors, perhaps with different levels of accuracy or certainty. For example, a value from empirical measurements or certified life cycle analyses may have a different predetermined certainty than a value pulled from an external database, which is in turn may have a mean value for all materials of a certain class. For an individual input of inputs 304, a factor may be overridden with a different number, for example one that comes from a local geographic average or a measurement in a supplier process 314 or customer process 312.

The process model 300 also includes a method of getOutputFootprint( ) 310 for calculating the footprint which typically involves multiplying the quantity of each input 304 by its associated factor from the factor lookup table 308 and summing them together as appropriate. The sum may be stored as a footprint output—the factor of the output may be computed as the footprint divided by the quantity of the output.

The process model 300 may also utilize various units of measurement including masses and other quantities associated with the process data 245 of FIG. 2 or process data 151 of FIG. 1, as could the factors. Therefore, each parameter of the function (i.e., method) may be a vector, list, or other data structure instead of a scalar. Thus, the function getOutputFootprint( ) may return footprint values that therefore involve summing the dot products of the quantities with the factors vector (or any mathematical operation that achieves the same result). The average footprint over some period of time could also be calculated, as could the average footprint for some quantity of material. The real-time data of the process data 245 may be time-series data that may be scaled based upon quantity type. In some embodiments, the time-series data is an amount of units per unit of time thereby making an integral over a period of time correspond to a total amount of an environmental impact value during that time. For example, if the environmental impact value is real-time data measuring wattage utilized at a measured point in time, this data may be integrated over a period of time to determine the total amount of joules consumed during that time (or Kilowatt-Hours, etc.).

In some embodiments of the present disclosure, the factor lookup table 146 may be dynamic. For example, the factors related to energy usage may be a function of time of day (at a particular location or set reference location). For example, during daylight, the environmental impact may be lower due to more energy production being based off of solar cells, but at night, the environmental impact may be higher because of the increased demand for energy production using natural gas. Thus, the factor lookup table 146 may have factors that are a function of time, function of the time of day, function of the date, based upon a time-varying reference, or may be generated by querying external data. For example, the factor lookup table 146 may query an energy producer to adjust the factor impact values on regular intervals if the energy producer had that kind of data available.

As mentioned above, a supplier can inherit the process model 300 such as the supplier process 314 and a customer can inherit the process model 300 as the customer process 312. Each party receiving the process model 300 (for example, a supplier receives the supplier process 314 and a customer receives the customer process 312 along a value chain) can customize it. For example, consider a chemical supplier of an ALD precursor and a semiconductor chip maker. Both run processes that are linked in the value chain. The supplier's process is the manufacturing process that converts raw materials into a chemical precursor. The customer's process combines the chemical precursor with other materials to produce a thin film. Each party can use the general process model 300 to map their process, and then use the provided factor table 308 or their own custom factors 308 to calculate their part of the footprint, or each party can use an inherited version of the process model 300, such as supplier process 314 or the customer process 312.

An aspect of the objects 300 is that each party can control their level of transparency of their footprint by offering interfaces to the other members of the ecosystem through inheritance and/or method declarations. For example, a supplier can use a supplier process 314 to override the getoutputfootprint( ) 324 method for calculating the footprint by making it public with differing levels of transparency: for example, by only giving the footprint generated through the standard process (the basic sustainability sticker), or by providing alternative methods that allow substitution of one or more ingredient such as shown by the getoutputfootprint(intput1, intput2) 326. By providing various customizable methods as interfaces instead of individual inputs, outputs, and processes, each member of the value chain can calculate or estimate footprints without revealing all details about the involved sub-components. In some embodiments, interfaces may be provided by the process model 300 (e.g., java interfaces) that may be implemented using any suitable access control system, such as permissions in a common data lake, a distributed system, blockchain, etc. If even more levels of security are desired, the process model 300 can incorporate any appropriate method for enhancing privacy, including data obfuscation, normalization, differential privacy, or algorithms from federated analytics, etc.

For example, consider a customer that utilized a customer process 312 that inhered from the process model 300. The customer process 312 may be added to, overridden, or simply inherited from, the steps 328, the inputs 330, the outputs 332, the factor lookup table 334, the getoutputfootprint( ) 336 method, the getOutputFootprint(input1) 338 method and/or the getOutputFootprint(intput1, intput2, . . . ) 340 method. In some embodiments, a call to “super( )” may be made to refer to the process model 300. In yet additional embodiments, one or more attributes or methods of the process model 300 may be declared “abstract” in some languages indicating that they must be implemented by an inheriting object. Continue with the example, if the supplier wanted to test how an alternative precursor would perform in the customer's process using the customer process 312 object, the customer can call the customer's footprint calculation method 338 or 340 with the alternative precursor as an input (e.g., input1, input2 . . . etc.) Thus, the supplier can try different input products to test the substantiality of downstream aspects of the manufacturing process thereby giving the supplier an ecosystem perspective instead of an individual or siloed perspective. Thus, multiple members of a value chain have agency to drive down the overall value chain's footprint, even if the footprint within an individual party does not change very much because a party has the ability to measure downstream footprint effects of their manufacturing decisions.

Consider another example where the supplier process 314 may be inherited from the process model 300. The steps 316, the input 318, the output 320, the factorLookupTable 322, the getOutputFootprint( ) 324, or getOutputFootprint(input1, input2) 326 may override the step 302, the input 306, the factorLookupTable( ) 308, and/or the getOutputFootprint(intput1, intput2) in accordance with the syntax of the computer language be utilized.

Consider yet another example comparing two different processes to produce solvated graphene. A raw material provider may have the option of producing two solvents. Solvent 1 is derived from petroleum, and solvent 2 is derived from wood pulp. Solvent 2 takes less fewer resources to produce, and therefore has a 2× lower carbon footprint compared to solvent 1. The sticker indicating the footprint caused by a particular subcomponent of a process on the solvents would only differ by a factor of 2. However, when used in the manufacturing process of graphene, solvent 2 has other advantages. It is much more efficient at producing solvated graphene, resulting in more concentrated solutions, less waste, more efficient packaging, transportation, etc. These advantages can add another ~10× to the lowering of the footprint in this process, which would not be visible on the sticker. The process model 300 allows the supplier in this example to propose a lower footprint process to the customer without compromising their security. By using the process model 300, the entities may coordinate in a way to minimize the overall environmental footprint. Each party is also free to seek out alternatives to reduce the aggregate footprints.

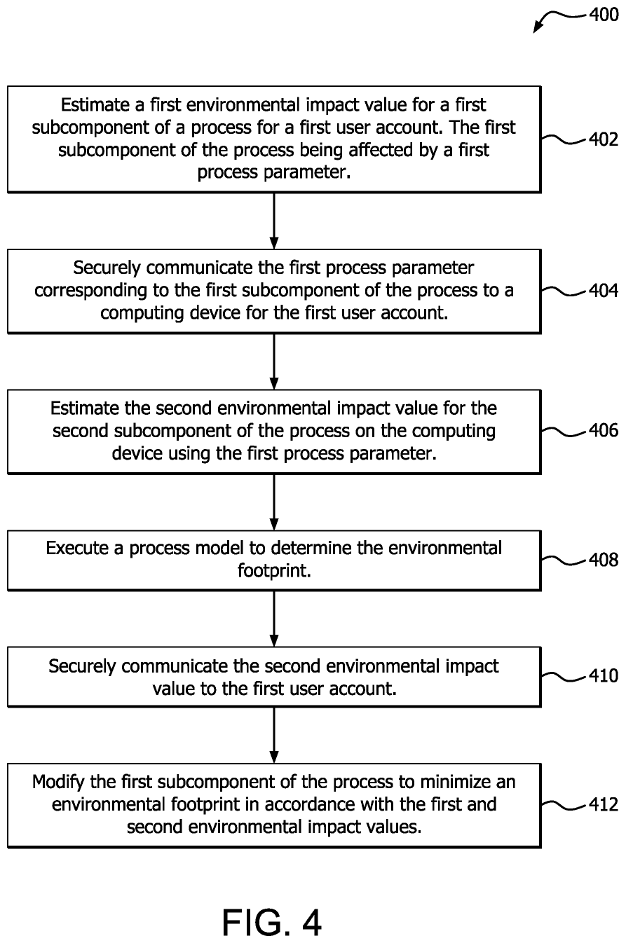

FIG. 4 is a flowchart of an example process 400. In some implementations, one or more process blocks of FIG. 4 may be performed by one or more of the computers 104, the mobile device 106, the cloud service provider 102, the computing device 200, or some combination thereof. The process 400 may include acts 402-412, additional acts, or fewer acts.

Act 402 estimates a first environmental impact value for a first subcomponent of a process for a first user account. The first subcomponent of the process may be affected by a first process parameter. Act 404 securely communicates the first process parameter corresponding to the first subcomponent of the process to a computing device for the first user account. Act 406 estimates the second environmental impact value for the second subcomponent of the process on the computing device using the first process parameter. The second environmental impact value may be affected by a second process parameter. A second user account may be associated with the second process parameter and the second subcomponent of the process. The first and second user accounts may be owned and/or controlled by separate parties, such as different parties in a production value chain.

Act 408 executes a process model (e.g., process model 300 of FIG. 3) to determine the environmental footprint. The process model may include one or more process steps (step as used in this context refers to manufacturing step as represented in a software executed by a computer). The process step may include one or more inputs and may calculate at least one output. The process model may include a factor lookup table configured to associate one or more materials with a normalized environmental footprint. The factor lookup table may include a hierarchical factor entry for each entry. The process model may be implemented as a smart contract on a blockchain and/or may interface with a common data lake

The process model of method 400 may be implemented on a secured distributed compute network. Optional acts may be such that a user can modify the process model in accordance with the first user account by inheriting the process model or overriding a behavior of the process model to estimate the first environmental impact value. Another optional act includes adjusting one or more transparency parameters in relation to the first and/or second user account.

Act 410 securely communicates the second environmental impact value to the first user account. The first environmental impact value may be an energy expenditure, a processing time, a solvent use, a transportation metric, a waste disposal amount, a greenhouse gas amount, a carbon footprint, and an ESG metric, and/or a water usage. The process model may additionally, alternatively, or optionally output at least one of a scope 1 environmental footprint, a scope 2 environmental footprint, and a scope 3 environmental footprint.

Act 412 modifies the first subcomponent of the process to minimize an environmental footprint in accordance with the first and second environmental impact values. Thus, a user via the first user account may modifying the first subcomponent of the process the user is in control of to reduce downstream negative environmental effects. Thus, the modification of the first subcomponent of the process may occur prior to an execution of the second subcomponent of the process. The first subcomponent of the process may be performed on a separate and distinct production line relative to the second subcomponent of the process Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Various alternatives and modifications can be devised by those skilled in the art without departing from the disclosure. Accordingly, the present disclosure is intended to embrace all such alternatives, modifications and variances. Additionally, while several embodiments of the present disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. And, those skilled in the art will envision other modifications within the scope and spirit of the claims appended hereto. Other elements, steps, methods and techniques that are insubstantially different from those described above and/or in the appended claims are also intended to be within the scope of the disclosure.

The embodiments shown in the drawings are presented only to demonstrate certain examples of the disclosure. And, the drawings described are only illustrative and are non-limiting. In the drawings, for illustrative purposes, the size of some of the elements may be exaggerated and not drawn to a particular scale. Additionally, elements shown within the drawings that have the same numbers may be identical elements or may be similar elements, depending on the context.

Where the term “comprising” is used in the present description and claims, it does not exclude other elements or steps. Where an indefinite or definite article is used when referring to a singular noun, e.g., “a,” “an,” or “the,” this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. This expression signifies that, with respect to the present disclosure, the only relevant components of the device are A and B.

Furthermore, the terms “first,” “second,” “third,” and the like, whether used in the description or in the claims, are provided for distinguishing between similar elements and not necessarily for describing a sequential or chronological order. It is to be understood that the terms so used are interchangeable under appropriate circumstances (unless clearly disclosed otherwise) and that the embodiments of the disclosure described herein are capable of operation in other sequences and/or arrangements than are described or illustrated herein.

1. A method of minimizing environmental impact throughout a value chain by communicating between process silos, the method comprising:
estimating a first environmental impact value for a first subcomponent of a process for a first user account, the first subcomponent of the process being affected by a first process parameter;
estimating a second environmental impact value for a second subcomponent of the process for the first user account, the second environmental impact value being affected by a second process parameter, a second user account being associated with the second process parameter and the second subcomponent of the process; and
modifying the first subcomponent of the process to minimize an environmental footprint in accordance with the first and second environmental impact values.

2. The method according to claim 1, the method further comprising:
securely communicating the first process parameter corresponding to the first subcomponent of the process to a computing device for the first user account;
estimating the second environmental impact value for the second subcomponent of the process on the computing device using the first process parameter; and
securely communicating the second environmental impact value to the first user account.

3. The method according to claim 1, wherein the first user account is prohibited from accessing at least one component of the second subcomponent of the process.

4. The method according to claim 1, wherein the first process parameter is one of a choice of material, a choice of use of a material, and a choice of and use of a material.

5. The method according to claim 1, wherein the modification of the first subcomponent of the process occurs prior to an execution of the second subcomponent of the process.

6. The method according to claim 5, wherein the first subcomponent of the process is performed on a separate and distinct production line relative to the second subcomponent of the process.

7. The method according to claim 1, wherein the first environmental impact value is one of an energy expenditure, a processing time, a solvent use, a transportation metric, a waste disposal amount, a greenhouse gas amount, a carbon footprint, a water usage, and an ESG metric.

8. The method according claim 1, wherein the first and second user accounts are separate parties.

9. The method according to claim 1, the method further comprising executing a process model to determine the environmental footprint.

10. (canceled)

11. (canceled)

12. (canceled)

13. The method according to claim 9, wherein the process model includes a factor lookup table configured to associate at least one material with a normalized environmental footprint.

14. The method according to claim 13, wherein the factor lookup table includes a hierarchical factor value for each entry.

15. The method according to claim 1, the method further comprising:
modifying a process model in accordance with the first user account; and
adjusting at least one transparency parameter in relation to the second user account.

16. (canceled)

17. (canceled)

18. (canceled)

19. (canceled)

20. (canceled)

21. The method according to claim 1, further comprising injecting obscuration noise into the first environmental impact value.

22. (canceled)

23. (canceled)

24. A system for minimizing environmental impact throughout a value chain by communicating between process silos comprising:
one or more processors configured to:
estimate a first environmental impact value for a first subcomponent of a process for a first user account, the first subcomponent of the process being affected by a first process parameter;
estimate a second environmental impact value for a second subcomponent of the process for the first user account, the second environmental impact value being affected by a second process parameter, a second user account being associated with the second process parameter and the second subcomponent of the process; and
modify the first subcomponent of the process to minimize an environmental footprint in accordance with the first and second environmental impact values.

25. The system of claim 24, the one or more processors further configured to:
securely communicate the first process parameter corresponding to the first subcomponent of the process to a computing device for the first user account estimate the second environmental impact value for the second subcomponent of the process on the computing device using the first process parameter; and
securely communicate the second environmental impact value to the first user account.

26. The system of claim 25, wherein the first user account is prohibited from accessing at least one component of the second subcomponent of the process.

27. (canceled)

28. (canceled)

29. The system of claim 24, wherein the first subcomponent of the process is performed on a separate and distinct production line relative to the second subcomponent of the process.

30-50. (canceled)
